(19) United States
(12) Patent Application Publication
(10) Pub. No.: US 2011/0169251 A1
(43) Pub. Date: Jul. 14, 2011

(54) VEHICLE BODY COMPONENT WITH INTEGRATED CRASH SENSOR

(75) Inventors: Thomas Arndt, Odenthal (DE); Markus Hagen, Koeln (DE)

(73) Assignee: FORD GLOBAL TECHNOLOGIES, LLC, Dearborn, MI (US)

(21) Appl. No.: 13/004,290

(22) Filed: Jan. 11, 2011

(30) Foreign Application Priority Data
Jan. 11, 2010 (DE) 10 2010 000 764.1

(51) Int. Cl. B60R 21/00; B62D 25/20; B29C 45/14

(52) U.S. Cl. 280/735; 296/193.07; 264/272.14

(57) ABSTRACT

A crash sensor for use in a safety system of an automotive vehicle is molded directly into a body component, with no intervening housing being provided. The body component may be a vehicle cross member, such as for reinforcing a radiator grill opening. The crash sensor is molded into the body component together with connections and/or connecting lines and/or plug-in connections and/or electronic circuit board. The crash sensor may be encased in a protective layer prior to being molded into the body component.

### CROSS-REFERENCE TO RELATED APPLICATIONS

This application claims foreign priority benefits under 35 U.S.C. §119 (a)-(d) to DE 10 2010 000 764.1, filed Jan. 11, 2010, which is hereby incorporated by reference in its entirety.

### BACKGROUND

1. Technical Field

The invention relates to automotive vehicle crash sensors such as are used to detect crashes or other impacts, and specifically to such a crash sensor that is integrated into a component of the vehicle body structure.

2. Background Art

A crash sensor, or impact sensor, is used in motor vehicles in order to detect an impact of the vehicle against an obstacle.

If the sensor has recognized an impact, it sends a signal to control devices in order to activate occupant protection systems. Depending on the equipment level of the vehicle, these protection systems include airbags, seat belt force limiters, seat belt tensioners, etc.

In this case the “packaging” of the sensors plays an important part. Thus, the sensor must be packaged and protected in such a manner that the sometimes very harsh environmental conditions, such as saline water and temperature fluctuations, do not influence or destroy the sensor, for example by corrosion, during the life of the vehicle. In addition, the process of installing the sensor and the associated electrical lines, control electronics and interfaces, etc., is complex and costly when producing the vehicle, and, because of its importance for the subsequent safety of the vehicle, must be checked using complex monitoring procedures.

For this reason crash sensors today are usually installed in modern vehicles in a sealed protective housing and fastened by screwing the housing to the body.

For example, a sensor integrated in a fastening element is known from WO 2007/024363 A1, which sensor includes a fastening element with a head portion and a shaft portion, the shaft portion being configured to be fastened to the body of a vehicle; an electronic sensor which is arranged on the head portion of the fastening element and is configured to monitor conditions relating to crash detection; and a shroud configured to encapsulate the electronic sensor and the head portion of the fastening element.

On the other hand, a method for producing a body part or a body attachment of a motor vehicle, and a corresponding body attachment, is known from DE 10 2007 057 259 A1, the body attachment having at least one sensor for detecting values of at least one physical variable, the sensor being integrated in the body attachment and the body attachment being produced in a master molding process, wherein the sensor is enclosed at least partially, during the master molding process for producing the body attachment, by the master molding material which is used in the master molding process and forms the body attachment.

Upon close examination of this document, it is found that although reference is generally made to a sensor, what is actually meant is the sensor module with a housing around the sensor itself, as disclosed in the embodiment. Furthermore, it is apparent from paragraph [0017-0018] that what is meant are sensors and their modules which have a signal-receiving side, which in turn is either positioned in an uncovered state on the outer skin of the vehicle or is surrounded by a thin layer of the master molding material of the body attachment.

It must therefore be assumed that both the orientation of the sensor module towards the outer skin of the vehicle and its arrangement in direct proximity to the outer skin in the body attachment play an important role. This, however, is not relevant to crash sensors.

Nevertheless, it continues to be desirable to provide a simplified manner of fastening, and therefore installing, crash sensors, including their ancillaries (the associated electrical lines, control electronics and interfaces, etc.), which simplified manner of fastening additionally provides protection against environmental conditions.

### SUMMARY

According to an embodiment disclosed herein, a body component for a motor vehicle comprises a core composed of a structurally rigid material, an outer layer molded over at least a portion of the core and composed of a plastic material, and a crash sensor molded into the outer layer. Electrical wires, leads, circuit boards, or similar electrical means for connecting the sensor to related components of the vehicle safety system may also be molded into the plastic outer layer.

According to another embodiment disclosed herein, the crash sensor is surrounded by a protective layer prior to being molded into the outer layer, so that the protective layer is interposed between the sensor and the outer layer.

According to another embodiment disclosed herein, a process for manufacturing a body component for a motor vehicle comprises providing a core made of a structurally rigid material, providing a crash sensor, and at least partially encasing the core and the crash sensor in a coating made of a moldable plastic material.

### BRIEF DESCRIPTION OF THE DRAWINGS

Further details and advantages of the invention are apparent from the following description of exemplary embodiments with reference to the drawing, in which:

FIG. 1 is a schematic perspective view of a body component for a radiator grille opening of a passenger car with a crash sensor;

FIG. 2 shows an enlarged schematic longitudinal section through the mounting location of the crash sensor of FIG. 1, and

FIGS. 3-8 show schematic longitudinal sections through the mounting locations of alternative embodiments of a crash sensor.

### DETAILED DESCRIPTION

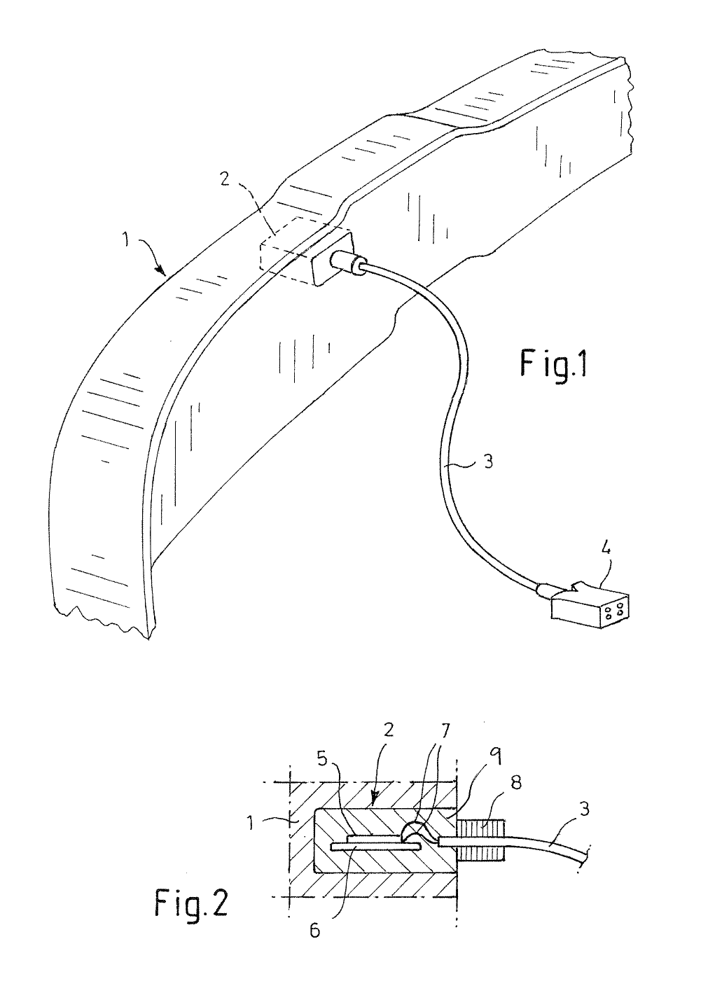

FIG. 1 is a schematic perspective view of a body component for an automotive vehicle denoted as a whole by reference numeral 1. In a possible embodiment, the body component is a reinforcing component for a radiator grille opening.

Body component 1 consists of a core made from a structurally rigid material, such as steel or reinforced composite material, and an outer layer made of a moldable plastic material. The outer layer may completely or partially surround the core. Such a hybrid part may be formed by a process such as over-molding or co-molding, as is well know in the art. Such hybrid components have the advantage of combining the structural strength of steel (or another structurally rigid material) with the adaptability of the plastics material, which allows the component to be adapted to requirements in an especially detailed manner.

The body component 1 has a crash sensor 2 molded into its central region. A connecting cable 3 leads out from the crash sensor 2 and is provided at its end with a connector 4 for connection to the onboard electronics.

In this case the connecting wires 7 of the connecting cable 3 are soldered directly to the sensor element 5 and the circuit board 6.

A seal 8 may also be molded integrally in the region of the exit of the connecting cable 3. This construction allows the seal 8 to serve and a “strain relief” and/or ensures that no material fatigue occurs through movement of the connecting cable 3, which may allow ingress of moisture, etc., into the sensor.

Thus, during assembly, only the connector or the connecting cable needs to be connected to the remainder of the vehicle. The sensor 2 can therefore be installed and tested during the preproduction of the body component, which is more easily controllable and less time-critical.

The crash sensor 2 is therefore molded into a protective layer 9 and only then molded into the body component 1; that is to say that it is provided with a surrounding plastic layer, usually an epoxy resin, prior to the installation process. The layer 9 protects the bare sensor and its ancillary connecting components (wires, leads, etc.), if necessary, against the conditions of the installation process, for example the injection of the plastic material which forms the coating. The protective material of layer 9 can also provide damping for the sensor with respect to vibrations and, depending on the configuration, can ensure further improved installation.

The protective layer 9 may advantageously be made of a material that is fusible with the material of the under the conditions of the molding-in process. In this way an especially intimate connection is achieved.

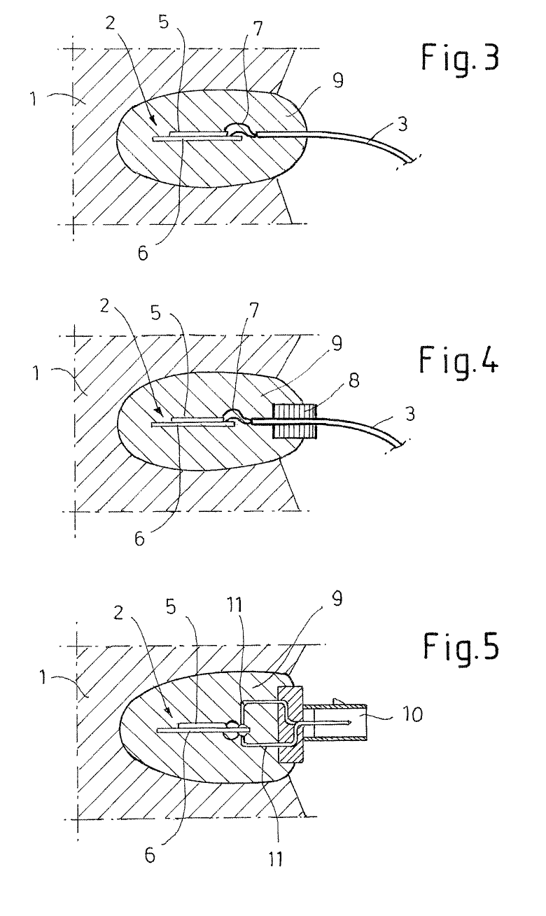

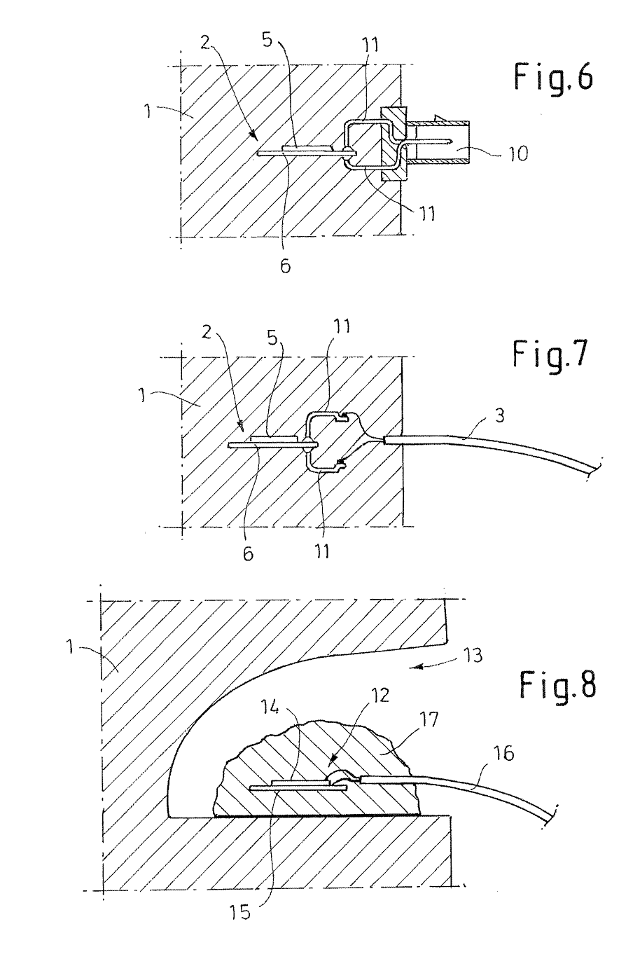

The embodiment of FIG. 3 corresponds to the first embodiment of FIGS. 1 and 2, apart from the omission of the additional seal 8. The embodiments of FIGS. 3 to 5 differ from the embodiment just discussed only in that, in their case, the sensor is molded in when encapsulated by means of a polymer protective layer. The differences will therefore be discussed below.

The embodiment of FIG. 4 corresponds to the embodiment of FIGS. 1 and 2, apart from the additional use of the protective layer 9.

The embodiment of FIG. 5 includes, in addition to the use of the protective layer 9, the embedding of a connector element 10, which forms one half of a plug-in connection for connecting the sensor 2 and its electronics to the vehicle.

In addition, the connector element 10 is connected to the sensor element 2 by means of connecting tags 11, which at the same time form the contacts in the connector element 10.

The embodiments of FIGS. 6 and 7 differ from the embodiments previously discussed essentially in that, in their case, the sensor 2 is molded-in directly during the injection molding process without any protective layer. That is to say that the actual sensor element 5, along with the interface circuit board 6 and the connecting lines 7, is molded directly into the plastics material of the body component 1 and so is directly surrounded by the material of the body component. That is to say, the sensor 2 is embedded, for example, during the injection molding process of said body component and is then enclosed by the plastics material.

The embodiment of FIG. 6 corresponds to the embodiment of FIG. 5 apart from the absence of the protective layer 9.

In the embodiment of FIG. 7, by contrast, although connecting tags 11 are used for the electrical connection, they are connected directly, for example soldered, to the connecting cable 4 inside the molded-in region, without a plug-in connection.

The last embodiment, from FIG. 8, differs from the embodiments previously described in that the sensor 12 is not molded-in in a form-fitting manner. Rather, the body component 1 includes a recess 13 within which the sensor element 14, with circuit board 15 and connecting cable 16, is bonded by means of the injection molding compound 17, which may be identical to the material of the body component 1.

Since the crash sensor is molded directly into a body component, without any intervening housing, a simplified installation can be combined with protection of the sensor against environmental influences. Installation is simplified because only the body component needs to be incorporated in the vehicle assembly line. Incorrect installation is also prevented, and the mounting location can be selected more freely, so that a more optimized position for the crash sensor can be used. In addition, the sensor is made smaller and more sensitive, because it is used without a housing.

The crash sensor is advantageously molded form-fittingly, with or without a protective layer, into a corresponding “recess” in the body component. Alternatively, depending on the configuration of the body component and of the optimum mounting location, the recess may be configured larger than the sensor and the sensor may therefore be molded-in “only with air”, in the manner of an integrated bond.

What is claimed:

1. A body component for a motor vehicle comprising:
a core composed of a structurally rigid material;
an outer layer molded over at least a portion of the core and composed of a plastic material; and
a crash sensor molded into the outer layer.

2. The apparatus of claim 1, further comprising connections associated with the crash sensor, the connections molded into the outer layer together with the sensor.

3. The apparatus of claim 2, wherein the connections comprise at least one of a connecting cable, a connecting line, a plug-in connection, and an electronic circuit board.

4. The apparatus of claim 1, wherein the crash sensor is molded into the body component when already molded into a protective layer.

5. The apparatus of claim 4, wherein the protective layer is made of a material that is fusible under conditions of the molding-in process of the crash sensor.

6. The apparatus of claim 3, further comprising a seal molded integrally with the crash sensor and surrounding the connections at their exit from the body component.

7. The apparatus of claim 1, wherein the crash sensor is molded form-fittingly into a corresponding recess of the body component.

8. The apparatus of claim 1, wherein the body component is a structural cross member.

9. An instrumented body component for a motor vehicle comprising:
a structural component having a rigid core and a plastic outer layer overlying, at least partially, the core; and
a crash sensor molded into the outer layer.

10. A process for manufacturing a body component for a motor vehicle comprising:
providing a core made of a structurally rigid material;
providing a crash sensor; and
at least partially encasing the core and the crash sensor in a coating made of a moldable plastic material.
